(19) United States
(12) Patent Application Publication
(10) Pub. No.: US 2003/0202011 A1
(43) Pub. Date: Oct. 30, 2003

(54) Information display unit and information display system

(75) Inventor: Masami Tsuchida, Saitama (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/421,802

(22) Filed: Apr. 24, 2003

(30) Foreign Application Priority Data
Apr. 26, 2002 (JP) P. 2002-127590

(51) Int. Cl. G09G 5/00

(52) U.S. Cl. 345/745

(57) ABSTRACT

An information display system for displaying information for customers and individuals. The information display system includes an information display unit and an information processing apparatus. The information display unit includes an input section which enters personal information, an identification section which identifies the entered personal information; and a display which displays individual-specific information corresponding to the identified personal information. The information processing apparatus includes a first storage which stores the individual-specific information corresponding to the personal information, a second storage that stores a table in which the personal information and the individual-specific information are related to each other; and a control section which references the table and causes the display to display the individual-specific information corresponding to the personal information.

The present disclosure relates to the subject matter contained in Japanese Patent Application No. 2002-127590 filed Apr. 26, 2002, which is incorporated herein by reference in its entirety.

### BACKGROUND OF THE INVENTION

1. Field of the Invention

This invention relates to an information display unit and an information display system and in particular to an information display unit and an information display system for displaying information for customers and individuals in a train, a bus, a taxi, an airplane, a movie theater, a hall, etc., for example.

2. Background Art

Hitherto, as an information display unit in a train, for example, a display such as a dot matrix of LEDs and a liquid crystal display placed on a wall, etc., of a train body have been available.

A destination guide, news, and the like for many and unspecified passengers are displayed on the display and further information concerning the region in which the trains run, season information, and the like are provided whenever necessary.

### SUMMARY OF THE INVENTION

However, the information display unit can provide the regional information and season information whenever necessary, but intends the information for many and unspecified passengers; the displayed information may concern a filed in which a specific person has no interest or may be unuseful information for a specific person; this is a problem.

It is hard for weak-sighted persons and elderly persons to see information displayed on the display at a distance from them; this is also a problem.

It is therefore an object of the invention to provide an information display unit and an information display system for displaying information corresponding to specific individuals. It is an object of the invention to provide an information display unit and an information display system for displaying individual-specific information in such a manner that weak-sighted persons and elderly persons can also see the information easily.

To achieve the object, the invention provides an information display unit including: an input section which enters personal information; an identification section which identifies the entered personal information; and a display which displays individual-specific information corresponding to the identified personal information.

Thus, the personal information indicating a specific individual and individual-specific information are related to each other, whereby the individual-specific information corresponding to the personal information can be displayed, and significant information can be displayed.

The input section may be a reception section which receives the personal information sent by communications. The personal information is input through communications, so that the personal information can be identified without input operation.

The reception section may have a reception range limited to a predetermined nearby range. The reception range is limited to a nearby range, so that the distance between the specific individual transmitting the personal information and the information display unit is shortened and consequently the display means can be brought close to the specific individual and the individual-specific information can be displayed even for weak-sighted persons and elderly persons in an easy-to-see manner.

The communications may be radio communications, so that directivity and the communication distance can be controlled easily.

The communications may be communications by an inductive action, so that power consumption can be suppressed as compared with the radio communications.

The reception section may receive the personal information retained in a radio tag, so that the personal information can be retained easily.

The reception section may receive the personal information retained in a mobile telephone, so that the personal information can be provided easily without providing new personal information.

The reception section may receive the personal information retained in an IC card, so that it is made possible to use the IC card also as a communication ticket, a credit card, etc., and the personal information used in a communication ticket, a credit card, etc., can be used.

The input section may be data input section for directly entering the personal information, so that communication facilities need not be constructed and the personal information can be entered reliably.

The data input section may include a touch panel, so that a part of the display can be used and it is made possible to miniaturize the unit.

The data input section includes an input key, so that when information is displayed on the display, it is also made possible to enter the personal information.

The personal information may include a plurality of attributes. The identification section identifies the personal information using at least one of the attributes. A part of the personal information is used, so that the individual can be identified based on the personal information low in concealment property and thus there is no fear of violating privacy.

The attribute includes at least one of a name, an age, an address, a gender, and an ID number, so that general personal information used in a communication ticket, a credit card, etc., can be used.

Preferably, the display has flexibility. When the unit itself is provided with flexibility, the flexibility of the installation place of the information display unit is increased.

Preferably, the display includes a selfluminous display. The selfluminous display maybe an organic electro luminescence display. When a selfluminous display is used, the individual-specific information can be displayed with high visibility. When an organic EL display is used, the display can be easily made slim and can be provided with flexibility.

The invention also provides an information display system, including: an input section which enters personal information; an identification section which identifies the entered personal information; a display which displays individual-specific information corresponding to the identified personal information; a first storage which stores the individual-specific information corresponding to the personal information; a second storage that stores a table in which the personal information and the individual-specific information are related to each other; and a control section which references the table and causes the display to display the individual-specific information corresponding to the personal information.

Thus, there can be provided an information display system that can display the information corresponding to a specific individual, thereby providing significant information and displays the individual-specific information in such a manner that weak-sighted persons and elderly persons can also see the information easily.

In the table, individuals and pieces of the individual-specific information may be related to each other in a one-to-one correspondence.

Thus, the individual-specific information related to the individuals in a one-to-one correspondence according to the ID numbers, etc., can be displayed on the information display unit.

In the table, individuals may be grouped according to an attribute, and groups or group combinations and pieces of the individual-specific information may be related to each other.

Thus, the individuals can be grouped according to an attribute of personal information (for example, age, gender, postal address, etc.,) and the information corresponding to the group can be displayed on the information display unit. Further, the information corresponding to combined conditions of groups can also be displayed on the information display unit.

Preferably, the input section is a reception section which receives the personal information sent by communications. The reception section includes a plurality of reception sections, each having reception range. The reception ranges does not overlap each other.

One reception range does not overlap another, so that if a plurality of information display units are placed closely to each other, interference between the adjacent information display units can be avoided and only the individual-specific information corresponding to the specific individual transmitting the personal information can be displayed.

### BRIEF DESCRIPTION OF THE DRAWINGS

The present invention may be more readily described with reference to the accompanying drawings, in which:

FIG. 1 is a block diagram to show an embodiment of information display units and an information display system according to the invention;

FIG. 2 is a perspective view to show an example of placing the information display unit according to the invention on a strap;

FIG. 3 is a schematic representation of the use state of the information display units according to the invention placed on the straps;

FIG. 4 is a schematic sectional view of an organic EL display used with the information display unit according to the invention;

FIGS. 5A to 5C show examples of an information table of the information display system according to the invention;

FIG. 6 is a flowchart to show an example of the operation of the information display system according to the invention; and

FIG. 7 is a perspective view to show places in a vehicle where the information display unit according to the invention can be placed.

### DETAILED DESCRIPTION OF THE PREFERRED EMBODIMENTS

Referring now to the accompanying drawings, there is shown a preferred embodiment of information display units and an information display system according to the invention. [0026]

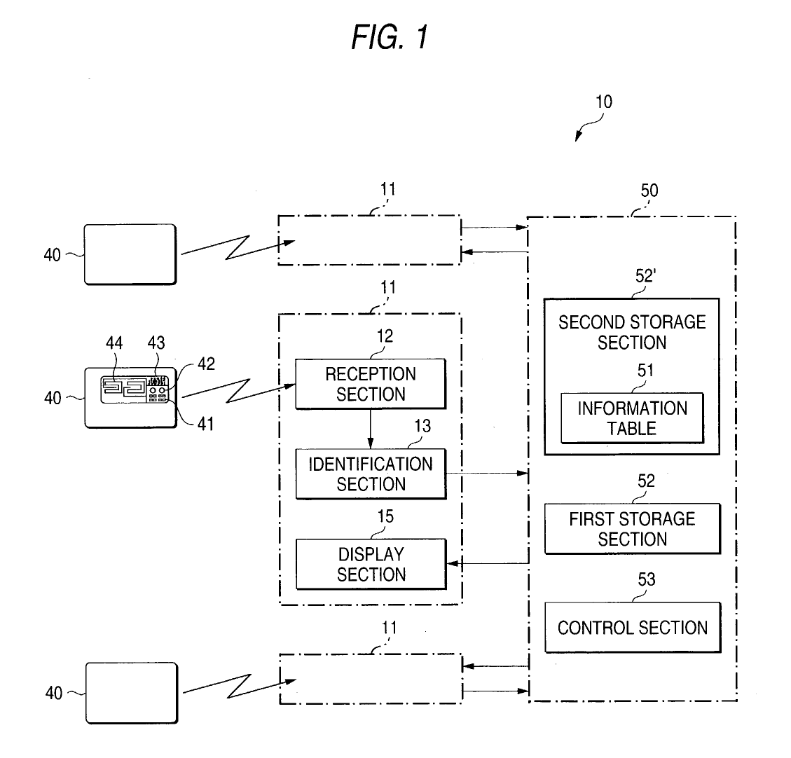

As shown in FIG. 1, an information display system 10 of an embodiment according to the invention includes a plurality of information display units 11 each made up of an input section (reception section) 12, an identification section 13, and a display section 15 and an information processing apparatus 50. The information processing apparatus 50 includes a first storage section 52, a second storage section 52′ storing an information table 51, and a control section 53. The information processing apparatus 50 transmits and receives information to and from each of the information display units 11.

Specifically, in the information display system 10, the reception section 12 of the information display unit 11 receives personal information (telephone number, age, address, ID number, etc.,) transmitted from an IC card 40 (noncontact), etc., carried by a customer in a train, a bus, a taxi, an airplane, a movie theater, a hall, etc., for example, and the identification section 13 identifies the personal information and transmits the personal information to the information processing apparatus 50.

Next, the control section 53 in the information processing apparatus 50 selects a specific address using the information table 51 based on the transmitted personal information, and transmits the individual-specific information stored in the storage area in the first storage section 52 corresponding to the selected specific address to the information display unit 11.

The transmitted individual-specific information (information fitted for the features of the age, address, gender, etc., of the individual, the hobby, taste, etc., of the individual, etc.,) is displayed on the display section 15 of the information display unit 11.

Each of the information display units 11 may include the first storage section 52, the second storage section 52′ and the control section 53 of the information processing apparatus 50.

The (noncontact) IC card 40 shown in FIG. 1 will be discussed in detail as one of means for transmitting personal information to the reception section.

As shown in FIG. 1, the IC card 40 includes a microcomputer 41, a chip capacitor 42, an RF-IC 43, a coil 44, etc.

The RF-IC 43 is an analog circuit for generating signals for communications and power supply from an induction field excited from the coil 44. The chip capacitor 42 serves as a power supply to The RF-IC 43 and the microcomputer 41.

The microcomputer 41 contains memory, such as EEPROM (Electronically Erasable and Programmable Read Only Memory), and personal information of the ID number, the name, the age, the address, etc., is stored in the memory.

The coil 44 excites an induction field for conducting communications by inductive action. The personal information is transmitted to the reception section 12 by the inductive action from the coil 44.

As the IC card 40, specifically an IC card having a complex function of a credit card, a prepaid card, a communication ticket, etc., or the like can be named.

In addition to the IC card 40, a radio tag or a mobile telephone can also be used with the information display unit and the information display system of the invention, and the personal information (telephone number, age, address, ID number, etc.,) contained in a radio signal transmitted from the radio tag or the mobile telephone may be used.

The reception section 12 receives the personal information sent by communications by radio or inductive action from the IC card 40, radio tag, mobile telephone, etc., as described above. If the signal input to the reception section 12 contains personal information, the identification section 13 recognizes the personal information for identifying the individual.

Further, the information display units and the information display system according to the embodiment will be discussed in detail by taking an example wherein the display section is placed on a strap in a train.

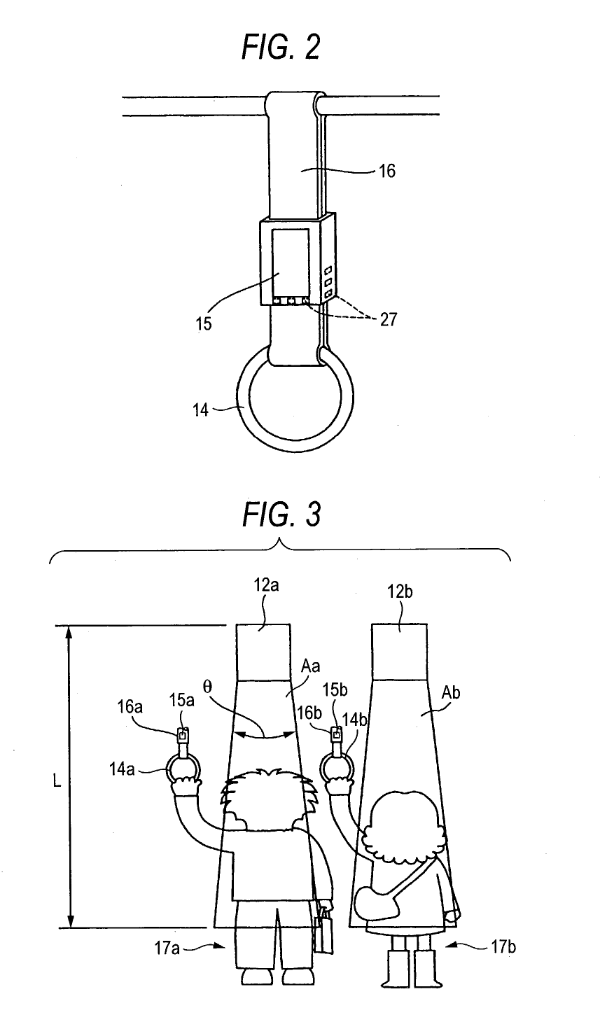

As shown in FIG. 2, the display section 15 of the information display unit is placed on a strap 16 hanging a ring 14 that a passenger holds on to. Further as shown in FIG. 3, one passenger can hold on to one of straps 16a, 16b, . . . , and reception sections 12a, 12b, . . . corresponding to the straps 16a, 16b, . . . are placed above the heads of passengers 17a, 17b, . . .

It is desirable that the reception range of the reception section 12a, 12b, . . . should be limited to the nearby range. Since one passenger can hold on to one of rings 14a, 14b, . . . , for example, the reception section 12a corresponding to the strap 16a receives only communications by radio or inductive action from the IC card, radio tag, mobile telephone, or the like carried by a passenger 17a holding on to the ring 14a of the strap 16a.

That is, it is necessary to suppress reception of communications by radio or inductive action from the IC card 40, radio tag, mobile telephone, or the like carried by another passenger 17b holding on to the adjacent ring 14b.

Specifically, as shown in FIG. 3, the reception section 12a (antenna, etc.,) is provided with directivity and a reception range Aa with reception angle θ and communication distance L limited for receiving communications by radio or inductive action only from the passenger 17a.

Further, preferably the reception range Aa does not overlap a reception range Ab of the reception section 12b of another information display unit.

More preferably, if the reception section 12a receives a radio wave or magnetism of another passenger 17b, etc., the strength of one radio wave or magnetism is compared with that of another radio wave or magnetism and the radio wave or magnetism higher in strength is received.

As shown in FIG. 2, input keys 27 (or a keyboard, etc.,) for the passenger 17a, 17b to directly enter data may be placed in the proximity of the display section 15 or a touch panel, etc., may be adopted as the display section 15 so that the passenger 17a, 17b directly enters his or her personal information for himself or herself.

That is, as shown in FIG. 3, the display section 15 of the strap 16a displays individual-specific information for the passenger 17a in the reception range Aa (the person holding on to the ring 14a), and the display section 15 of the strap 16b displays individual-specific information for the passenger 17b in the reception range Ab (the person holding on to the ring 14b).

If the passenger in the reception range of the reception section does not have an IC card, radio tag, mobile telephone, or the like for transmitting personal information or no person exists in the reception range, individual-nonspecific general information may be displayed.

Alternatively, a sensor, etc., senses whether or not a person holds on to a strap and if no person holds on to the strap, the power of the display section maybe turned off, etc., so as not to display information.

Preferably, an organic EL display rich in flexibility is adopted as a display used as the display section placed on the strap. The structure of the organic electro luminescence (EL) display will be discussed.

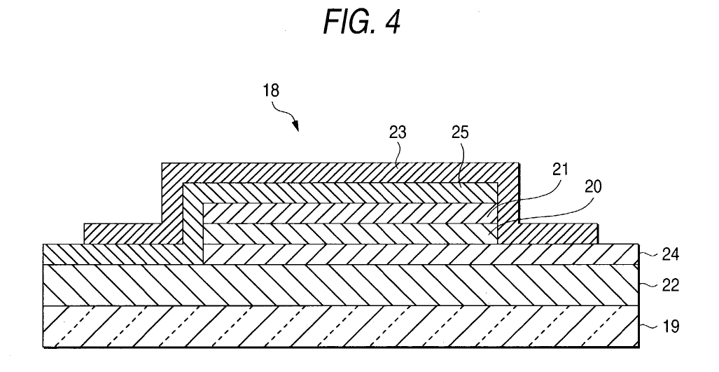

An organic EL display 18 has a schematic structure as shown in FIG. 4, wherein a luminescent function film 21 made of an organic substance for emitting light upon application of an electric current, a hole transport layer 20 for transporting holes, and the like are sandwiched between a transparent electrode 24 (ITO: Indium-tin oxide, IZO: Indium-zinc oxide, etc.,) and a negative electrode 25 (Al—Li, Mg—Ag, etc.,) as a positive and negative electrode pair on the back (upper face in FIG. 4) of a plastic substrate 19 rich in flexibility used as a display surface.

Further, a water inhibition film 22 for inhibiting entry of water from the outside is placed between the transparent electrode 24 and the plastic substrate 19, and aback protection film 23 is placed on the upper face of the negative electrode 25 as the back.

The organic EL display 18 causes the luminescent function film 21 to emit light matching the shape of individual-specific information to be displayed, thereby displaying the individual-specific information through the plastic substrate 19.

The organic EL display 18 is used as the display section 15 placed on the strap 16 as shown in FIG. 2, whereby the display section can be made slim so that it can be attached to a limited space of the strap 16.

The display, which is flexible, can also be attached directly to a flexible member such as the strap 16.

Since the display is placed on the strap, it can be placed near each person as compared with the case where the display is placed on a wall, etc., of a vehicle, so that even a weak-sighted person or a person even in a crowed vehicle can easily view the display.

Next, the information table 51 of the information display unit 11 will be discussed in detail.

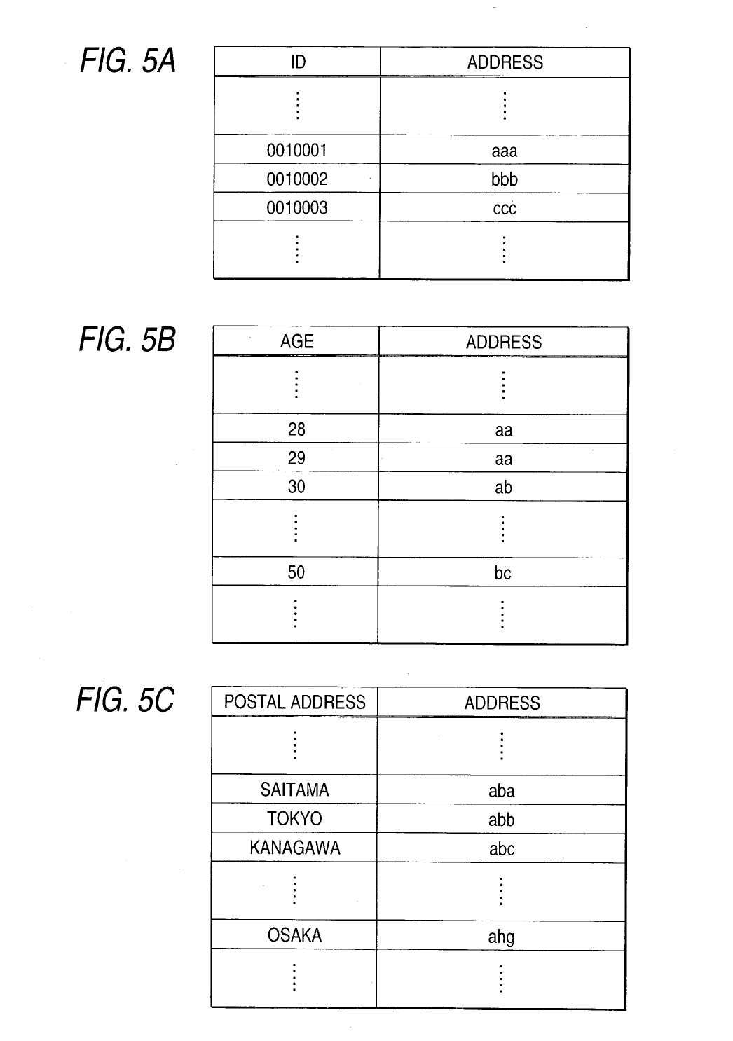

The information table 51 is a table for relating personal information and an address of data (individual-specific information) in the first storage section 52 to each other. For example, ID number 10001 of an individual is related to address aaa in the database, 10002 is related to bbb, and 10003 is related to ccc, as shown in FIG. 5A.

The personal information may be any other than the ID number, such as age as shown in FIG. 5B or postal address as shown in FIG. 5C.

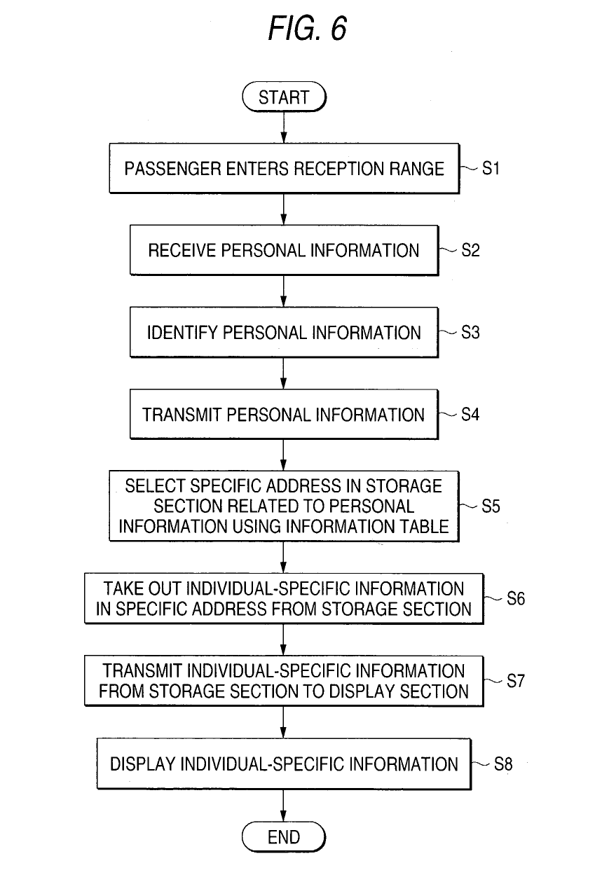

Next, specific operation of the information display system 10 will be discussed with reference to FIGS. 2 and 3 based on a flowchart of FIG. 6.

In FIG. 2, first the passenger 17a enters the reception range Aa (holds on to the strap 14a).

Accordingly, the reception section 12a receives a communication signal by radio or inductive action containing personal information transmitted from the IC card 40, mobile telephone, or the like carried by the passenger 17a.

Next, the identification section 13 detects the personal information (telephone number, age, address, ID number, etc.,) contained in the signal received in the reception section 12a, and identifies the passenger 17a.

Then, the personal information (telephone number, age, address, ID number, etc.,) is transmitted to the information processing apparatus 50.

The specific address in the first storage section 52 related to the transmitted personal information is selected using the information table 51.

Information (individual-specific information) corresponding to the passenger 17a is stored at the specific address in the first storage section 52, and the individual-specific information stored at the specific address is taken out from the first storage section 52.

The information (individual-specific information) corresponding to the passenger 17a is transmitted from the information processing apparatus 50 to the display section 15.

Last, the individual-specific information suited for the passenger 17a is displayed on the display section 15.

The information thus displayed on the display section 15 is the individual-specific information corresponding to the personal information (telephone number, age, address, ID number, etc.,) of the passenger 17a and therefore becomes interesting or valuable information for the passenger 17a.

The individual-specific information need not be of one type, of course; it can be transmitted one after another from the information processing apparatus 50 for changing display information on the display section 15.

The individual-specific information may be information varying from one person to another or display information may be selected as the persons are grouped in such a manner that the same information intended for youths (stored at address aa) is displayed for the persons of ages 28-29 and another piece of information (stored at address ab) is displayed for the persons of age 30, for example, as shown in FIG. 5B. Further, the persons may be grouped according to any other attribute of the personal information than the age, such as gender or postal address, or display information may be selected corresponding to combined conditions of groups.

The individual-specific information may be information indicating the interesting genre for the individual or hobby specification information, for example. In this case, the information processing apparatus may further display additionally provided genre-by-genre information based on that information.

According to the information display units and the information display system 10 described above, information is displayed based on the personal information of the passengers 17, so that information suited for each person can be displayed efficiently.

Since the personal information for identifying each person is automatically detected from mobile telephones, IC cards, radio tags, etc., widely and generally carried by persons, the information display system of the invention can identify a large number of human beings and can be widely applied.

It is to be understood that the information display units and the information display system according to the invention are not limited to the specific embodiment described above and can be modified, improved, etc., appropriately.

For example, in the embodiment described above, the organic EL display 18 is used as the display section 15; in addition, an inorganic EL display, a display of LEDs, or the like can also be used.

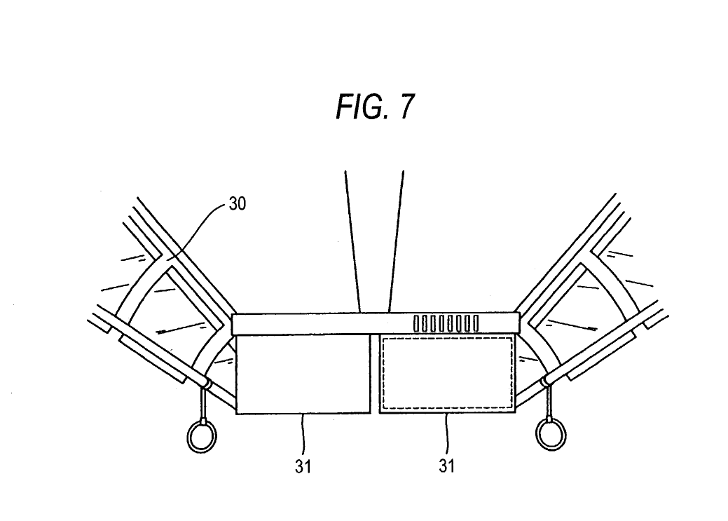

The strap 16 in a vehicle is shown as the installation position of the display section 15 by way of example, but the display section 15 may be installed at any place where it can be recognized from the inside; for example, the display section 15 may be installed on a ceiling or a floor. As shown in FIG. 7, the display section 15 can also be attached directly to an inner wall 30 in a vehicle or can also be hung like a hanging advertisement 31 in a vehicle. Further, the display section 15 can also be attached to the rear of a seat in a train, a bus, a taxi, an airplane, a movie theater, a hall, etc.

As described above in detail, according to the invention, the personal information indicating a specific individual and the individual-specific information are related to each other, whereby the individual-specific information corresponding to a specific individual can be displayed and significant information can be provided. Further, the information can be displayed in such a manner that weak-sighted persons and elderly persons can also see the information easily.

What is claimed is:

1. An information display unit comprising:
an input section which enters personal information;
an identification section which identifies the entered personal information; and
a display which displays individual-specific information corresponding to the identified personal information.

2. The information display unit as claimed in claim 1,
wherein the input section is a reception section which receives the personal information sent by communications.

3. The information display unit as claimed in claim 2,
wherein the reception section has a reception range limited to a predetermined nearby range.

4. The information display unit as claimed in claim 2, wherein the communications are radio communications.

5. The information display unit as claimed in claim 2, wherein the communications are communications by an inductive action.

6. The information display unit as claimed in claim 2, wherein the reception section receives the personal information retained in a radio tag.

7. The information display unit as claimed in claim 5, wherein the reception section receives the personal information retained in a mobile telephone.

8. The information display unit as claimed in claim 2, wherein the reception section receives the personal information retained in an IC card.

9. The information display unit as claimed in claim 1, wherein the input section is data input section for directly entering the personal information.

10. The information display unit as claimed in claim 9, wherein the data input section includes a touch panel.

11. The information display unit as claimed in claim 9, wherein the data input section includes an input key.

12. The information display unit as claimed in claim 1, wherein
the personal information includes a plurality of attributes; and
the identification section identifies the personal information using at least one of the attributes.

13. The information display unit as claimed in claim 12, wherein the attribute includes at least one of a name, an age, an address, a gender, and an ID number.

14. The information display unit as claimed in claim 1, wherein the display has flexibility.

15. The information display unit as claimed in claim 1, wherein the display comprises a selfluminous display.

16. The information display unit as claimed in claim 15, wherein the selfluminous display is an organic electro luminescence display.

17. An information display system, comprising:
an input section which enters personal information;
an identification section which identifies the entered personal information;
a display which displays individual-specific information corresponding to the identified personal information;
a first storage which stores the individual-specific information corresponding to the personal information;
a second storage that stores a table in which the personal information and the individual-specific information are related to each other; and
a control section which references the table and causes the display to display the individual-specific information corresponding to the personal information.

18. The information display system as claimed in claim 17, wherein in the table, individuals and pieces of the individual-specific information are related to each other in a one-to-one correspondence.

19. The information display system as claimed in claim 17, wherein in the table, individuals are grouped according to an attribute and groups or group combinations and pieces of the individual-specific information are related to each other.

20. The information display unit system as claimed in claim 17, wherein the input section is a reception section which receives the personal information sent by communications;
the reception section includes a plurality of reception sections, each having reception range; and
the reception ranges does not overlap each other.

21. The information display unit system as claimed in claim 17, further comprising a portable section having a third storage and a transmission section;
wherein the third storage stores the personal information; and
the transmission section transmits the personal information to the input section by radio communication.
